(19) United States
(12) Patent Application Publication
(10) Pub. No.: US 2015/0347586 A1
(43) Pub. Date: Dec. 3, 2015

(54) CALENDAR EVENT PERIPHERAL VIEW

(71) Applicant: Microsoft Corporation, Redmond, WA (US)

(72) Inventors: Doreen Nelson Fasen, Kirkland, WA (US); Katherine Mary Everitt, Seattle, WA (US); Roshin Lal Ramesan, Kirkland, WA (US)

(73) Assignee: Microsoft Corporation, Redmond, WA (US)

(21) Appl. No.: 14/289,301

(22) Filed: May 28, 2014

(51) Int. Cl. G06F 17/30; G06Q 10/10

(52) U.S. Cl. CPC G06F 17/30867; G06Q 10/109; G06F 17/30011; G06F 17/30241

(57) ABSTRACT

Techniques are disclosed for enhancing the presentation of calendar items by providing a calendar event peripheral view of relevant event-related information with a detailed view of a calendar item. The relevant event-related information may be determined by using the item information, such as date and time and location of an event, to gather information from a wide variety of sources, including at least one of an associated calendar of the user and accessible information feeds.

### BACKGROUND

Users have increasingly turned to electronic calendar applications to help them manage, schedule, and remember appointments, meetings and other events. Many calendar applications enable a user to manage and view multiple calendars. The multiple calendars may be the user's own calendars, for example a work calendar and a personal calendar, or even include other people's calendars to which the user has been granted access, for example calendars of members of a corporate account and calendars specifically made available by another person. Coordinating the time for an event has become easier through shared calendars, for example, as part of a scheduling assistant that looks for times commonly available to invitees to a meeting.

In some cases, calendaring application functions are built into larger information management applications also containing messaging, contact management, and other services. In other cases, calendar applications are relatively stand-alone, such as when they are built as discrete “apps” available to mobile device users.

### BRIEF SUMMARY

Techniques are disclosed for enhancing the presentation of a calendar item by presenting a peripheral view of event-related information relevant to at least a time and location associated with an event identified from a calendar item. The peripheral view may be presented as part of a detailed view of a calendar item and can include information retrieved from at least a calendar associated with the user using the time/date and location information identified from the detailed view of the calendar item. In some cases, people and even documents associated with an event may be utilized.

In some implementations, the information retrieved (and presented) from the calendar(s) associated with the user can include not only conflicting events (such as appointments, meetings or tasks), but events happening around the same time and/or near the same location. The calendars associated with the user may include any of a personal calendar, a family member calendar, a work calendar, a colleague's calendar, a work team calendar, and the like.

In some implementations, the information can be retrieved from accessible information feeds instead of or in addition to associated calendars. Accessible information feeds may include any of a public calendar, a rating service, a traffic data feed, a weather data feed, and the like. Such information feeds may be used to facilitate the inclusion of up-to-date information as part of the peripheral view.

Contextual information such as, but not limited to, user history, invitee location, invitee history, and even social media accounts for the user may be used to generate event-related information.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIGS. 1A-1C illustrate an example operating environment in which calendar items may be enhanced with a calendar event peripheral view.

FIG. 2 illustrates an example detailed view of a calendar item with peripheral view.

FIG. 3 illustrates an example process flow for enhancing a calendar item with a calendar event peripheral view.

FIGS. 4A-4C illustrate an example scenario in which a calendar item may be enhanced with a calendar event peripheral view.

FIGS. 5A and 5B present block diagrams illustrating components of systems that may be used to implement the techniques described herein.

FIG. 6 illustrates an example system architecture in which the described systems and techniques may be carried out.

### DETAILED DESCRIPTION

Techniques are disclosed for enhancing the presentation of calendar items. The described techniques may enhance a user's interaction with a calendar application and facilitate the planning of, or the scheduling related to, an event. Within many calendar applications (and personal information management systems), a calendar item is often referred to as an appointment or a meeting depending on whether the item includes invitees. In any case, a calendar item is used to indicate an event for the user.

Users of calendar applications may be assisted in creating and managing their events by having access to a peripheral view of event-related information while drafting, editing, or otherwise viewing a calendar item for an event. The “periphery” of an event refers to the things that happen around an event and which may be related to the event or to a date/time, location, or person (or even a document) associated with the event. These things that happen around the event can be referred to as “event-related information” and can provide context. The “peripheral view” or “calendar event peripheral view” presents that information.

A user may be familiar with having multiple calendars available within a calendar application. However, the peripheral view can provide relevant context to a user as part of a detailed view of a calendar item, which may help in planning an event. In addition, event-related information from outside the user's associated calendars can be included in the peripheral view.

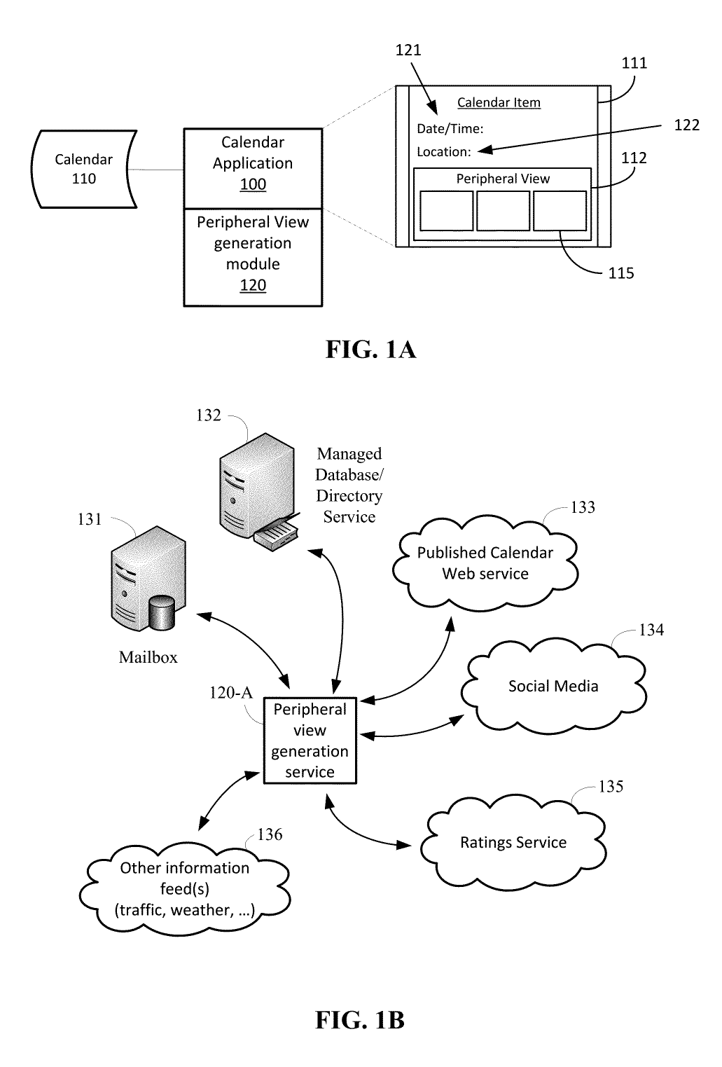

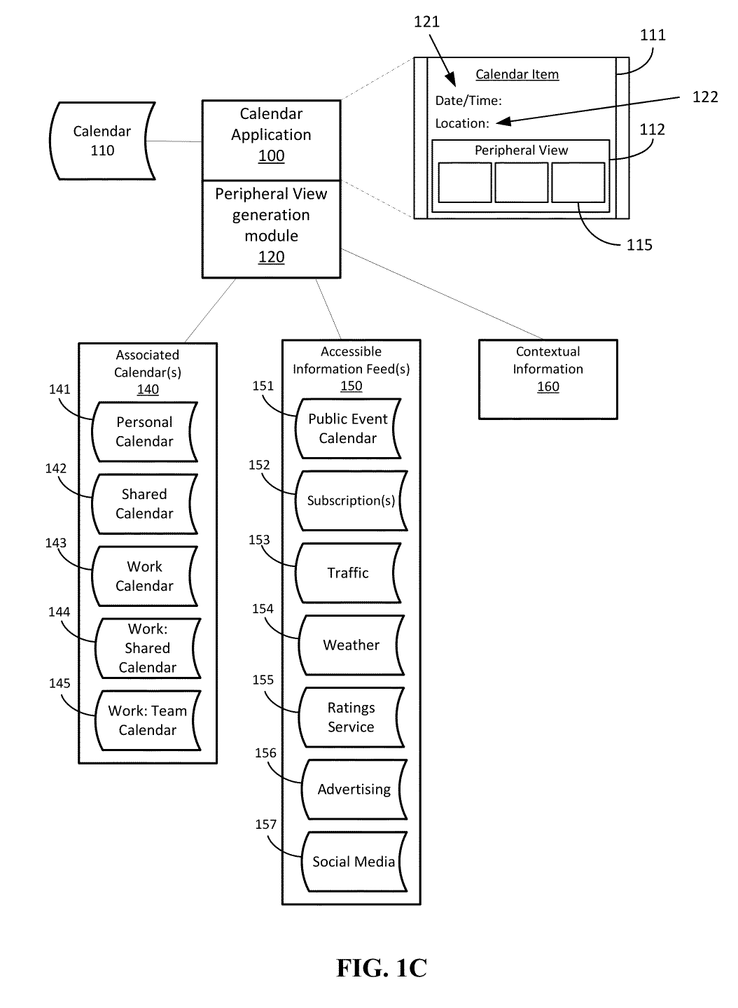

FIGS. 1A-1C illustrate an example operating environment in which calendar items may be enhanced with a calendar event peripheral view. Referring to FIG. 1A, calendar application 100 can manage a user's calendar 110 and provide functionality and user interfaces for creating, editing, and viewing a calendar item 111 of the calendar 110 managed by the calendar application 100.

A “calendar application” refers to a software program that enables the user to generate, record, and manage scheduling entries in the form of calendar items. Sometimes calendar applications carry out only the calendaring function, but often calendaring applications are integrated into personal information management applications that have multiple functions.

The calendar application 100 may include components that are local (at a user's device) and components that are residing on a server, which can provide access and syncing of calendar items across multiple devices and/or storage of the user's calendar items. In various implementations, the calendar application 100 may be a rich client on a desktop or laptop (e.g., Microsoft Outlook®), a mobile client on a mobile device (e.g., a calendar application on the Android OS®, iCal for iOS®, Outlook® for Windows Phone®, or Cal from Any.do), or part of an application running as cloud services accessible via a web browser (e.g., Google® Calendar and Outlook.com™).

In some cases, a calendar application connects to a larger personal information management service that forms a coordinated storage system for more than one user. Examples of personal information management services that may provide interconnectivity functions between users are Microsoft® Exchange, Outlook.com™, and Google® Calendar. A Microsoft® Exchange Server installation at a company can enable coordination of calendaring functions between members of the company, while Gmail®, through Google Calendar, for example, enables users in the general public to share calendars with one another.

According to various implementations described herein, a calendar event peripheral view 112 can be presented in a detailed view of calendar item 111 to provide context for the user, in the form of event-related information 115. The context for the user—the event-related information 115—can be generated by a peripheral view generation module 120 associated with the calendar application 100.

The peripheral view generation module may be integrated with the calendar application 100 or provided as a separate service for the calendar application 100.

In some cases, the peripheral view generation module 120 can include a peripheral view generation service 120-A such as illustrated in FIG. 1B. Referring to FIG. 1B, a peripheral view generation service 120-A can query a variety of sources for event-related information. For example, when the peripheral view generation service 120-A identifies or receives identified item information such as date/time 121 and location 122 information of the calendar item, the peripheral view generation service 120-A can search for information related to the date, time, and location (alone or in any combination) from a variety of sources. The results from the various sources can be filtered and formatted by the peripheral view generation service 120-A (or another component of the peripheral view generation module 120). The search, using at least the date/time 121 and location 122 information identified from the calendar item, may be conducted in at least an associated calendar for the user.

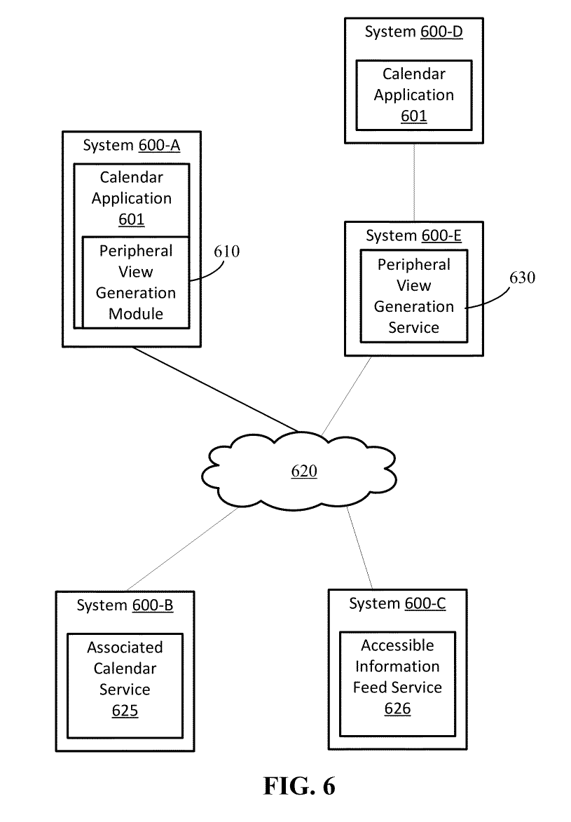

Associated calendars may be accessible to the peripheral view generation module 120 (and/or service 120-A) in several ways. In some cases, the interchange may be accomplished using native application programming interface (API) functions of the underlying calendar service (described in further detail with respect to FIG. 6). Some calendars are often accessible through sharing features of the personal information manager service underlying the calendar application. In a company using Microsoft® Exchange Server, for example, additional calendars may be viewable through Microsoft® Exchange Server intrinsic functions. As another example, personal users may share their Google®Calendar information with other users upon request, and the interchange is handled by functions intrinsic to the personal information service. In other cases, the interchange may occur over a standard calendar access transport and interchange method (e.g., iCalendar interchange).

In addition to associated calendars, the search, using at least the date/time 121 and location 122 information identified from a calendar item, may be conducted with respect to other calendars and information sources, including information sources and feeds of public or subscribed event calendars. Such information sources and feeds may provide up-to-date information.

Information sources and feeds of public or subscribed event calendars (see e.g., FIG. 1C) may be accessed via various methods familiar to practitioners in the art. For example, iCalendar is a file format allowing Internet users to send meeting requests to other users by sharing files (over email or other methods) that are formatted with a particular file structure. Using iCalendar, one or more calendar events may be shared by a public or subscribed event service which is then received and processed by the peripheral view generation module 120.

In addition, iCalendar event files may be shared and accessed programmatically through the HTTP protocol using extensions to the Web Distributed Authoring and Versioning (WebDAV) protocol. These extensions include Calendaring Extensions to WebDAV, or CalDAV, and they allow client calendar applications to access scheduling information on a remote server such as a web server. Thus, an application or peripheral view service may “pull” relevant calendar information from web servers and feeds that allow subscriptions or programmatic access to their calendars using iCalendar and CalDAV. Other methods for sharing iCalendar events and calendars, for example the Really Simple Service (RSS) feed interchange format, are also available. In addition to iCalendar interchange formats, vendor-specific interchange methods such as application programming interfaces (APIs) and XML formats may also be used.

Clearinghouse services, such as those available at Zapaday.com, allow users to quickly subscribe to calendars across a wide variety of interests and may provide the sources for calendar event-related information. Facebook® Events allows users and organizations to publicly display calendar information and also allow syncing of calendar events though established calendar formats.

Examples of sources that may be queried by the peripheral view generation service 120-A include one or more of a mailbox (or standalone calendar) server 131 (e.g., providing associated calendars), a managed database or directory service 132, a published calendar web service 133, social media 134, ratings service 135, and/or other information feeds 136 (e.g., traffic, weather, and the like). The peripheral view generation service 120-A may communicate with these sources (and in some cases with the calendar application 100) over a network. The network can include, but is not limited to, a cellular network (e.g., wireless phone), a point-to-point dial up connection, a satellite network, the Internet, a local area network (LAN), a wide area network (WAN), a WiFi network, an ad hoc network, an intranet, an extranet, or a combination thereof. The network may include one or more connected networks (e.g., a multi-network environment) including public networks, such as the Internet, and/or private networks such as a secure enterprise private network.

It should be noted that the retrieval of information or content from associated calendars, accessible information feeds, and other sources may be carried or implemented in services external to, or partially external to, the calendar application. The retrieved information and relevant event-related information can be presented or rendered as a view within the calendar item entry interface or in other interfaces.

Turning to FIG. 1C, through the peripheral view generation service 120-A the peripheral view generation module 120 may access associated calendars 140 and accessible information feeds 150 for event-related content. In some implementations, the information retrieved (and presented) from the associated calendar(s) 140 and the accessible information feeds 150 can include not only conflicting events (such as appointments, meetings or tasks), but events happening around the same time and/or near the same location. In some cases, a current date and time may be used to determine relevant information. In some cases, the identified date and the times before and after the identified time may be used. In some cases, a future date and time may be used. In some cases, any of these three alone or in combination may be used.

User's associated calendars 140 may include, but are not limited to, one or more of personal calendar(s) 141, shared calendar(s) 142 (e.g., family member's calendar), user's work calendar(s) 143, shared work calendar(s) 144, and work team calendar(s).

The calendars included in the user's associated calendars 140 may depend upon the calendar 110 within which the user is interacting. For example, if the user is entering a new calendar item to a work calendar (or viewing a detailed view of the calendar item), the associated calendar may be the user's personal calendar 141 used for noting home-related or social obligations (and vice versa).

The shared work calendar(s) 144 may include the calendars of certain co-workers and be searched for event-related information based, for example, on user history and/or inclusion as an invitee to the event. Another kind of work-shared calendar might show informative lunchtime events, seminars, or speakers that employees may attend. Thus, a calendar event to meet with a work colleague over lunch might include peripheral view content containing such shared calendar events for that day and time. Another work calendar might show work team calendar events 145 containing, for example, scheduled departmental trainings that may need to be considered in scheduling events.

The accessible information feed(s) 150 may include, but are not limited to, public event calendar(s) 151, subscribed event calendar(s) or other calendar-related subscriptions 152, traffic information feed(s) 153, weather information feed(s) 154, ratings service(s) 155, advertising 156, and social media 157.

Public event calendar(s) 151 can include calendars made publically available through Google Calendar, iCalShare and the like, a calendar from an organization such as a fine arts organization, a Chamber of Commerce, and the like; and a calendar from a venue such as a sport's stadium, concert hall, movie theater and the like. Of course, the particular calendars searched for the event-related information may depend on implementation as well as user settings.

The subscribed event calendar(s) or other calendar-related subscriptions 152 can include calendars to which the user has actively subscribed (or otherwise indicated interest). For example, if the user is interested in the local major league baseball team, he or she may actively subscribe to the team's schedule. As a further example, the user may subscribe to a calendar of performances by a favorite band that frequently plays in the city or region. By subscribing to the band's calendar, the peripheral view may present performances that occur at or near the same time and place as the event being scheduled. The subscribed event calendar(s) or other calendar-related subscriptions 152 may include publically available event calendars (e.g., public event calendar(s) 151) or private calendars to which a specific subscription or permission is needed to receive the information from the calendar.

Traffic 153 and weather 154 feeds may be accessed in certain implementations. For example, a feed published by the state or regional highway authority containing road closures and other traffic events may be accessible from a traffic feed 153. As another example, the weather forecast for an event can be accessible from a weather feed 154, for example available from Yahoo!®, The Weather Channel® or AccuWeather.com®.

Ratings service(s) 155 can include review sites such as Yelp®, TripAdvisor®, and Google® Restaurant Reviews. The information from the ratings service 155 may be used to filter results for presentation to a user in the peripheral view 112 and/or provide an indication of the ratings, assessments, and reviews of the selected venue or other venues proximate to the chosen event location (or otherwise determined to be relevant for the user). For example, if the planned event description/location is “Lunch at Super Sushi,” the venue rating service may present additional Sushi restaurant options (such as those with a higher customer rating) proximate to the initially planned location. As another example, the peripheral view 112 can include a user-selected filter providing popular establishments near an indicated location (or relevant in some other manner) that are rated based on the ratings service 155. As an additional example, occasionally a planned venue may go out of business between visits by the user, or even be closed on the planned day of the week. A ratings service 155 may have such information as hours and closed/open status available and such information can be used to notify the user in the peripheral view of closures or other relevant information.

Advertising 156 may also be used to present event-related information. The advertising 156 can include a feed containing paid placements for venues and events.

Social media 157 may provide information about events and user interests and/or invitee interests. For example, users of Facebook® often “like” entities or organizations (e.g., restaurants, businesses, bands) though the Facebook “like” button present on the organization's web page or elsewhere. The information about user “likes” and preferences may be accessible programmatically through Facebook API interchange functions.

Another information feed can be from an aggregator/personal assistant application and service such as Google Now™ available from Google Inc., Ski® available from Apple Inc., and Cortana® available from Microsoft Corp., which pull information from news sites and local (client) information.

Once event-related information is retrieved from the accessible sources, the peripheral view generation module 120 can filter, sort, or otherwise determine the particular event-related information to be displayed to the user. Contextual information 160 can be used to facilitate the search for related information or to determine the particular event-related information for display to the user.

Contextual information 160, such as user history (e.g., from previous calendar items), and publically accessible information or specifically permitted (by the associated person) private information pertaining to invitee location, invitee history (from the invitee's account), communications (e.g., email) from or to the user (and/or invitee) that include a discussion or other mention of the event, and even social media accounts for the user (and/or invitee), may be used to generate event-related information. For example, things that a user (or an invitee) “likes” on Facebook® may be used to determine the particular event-related information presented as part of the peripheral view.

As a specific example, Facebook “likes” for the user or both the user and an invitee might indicate that the user (or both the user and the invitee) like a certain art museum. Using this information, the peripheral view generation module 120 might present the art museum café as an alternative venue to the originally planned restaurant location.

Historical information for the user, a group of users or even for a calendar application service as a whole may be used to refine suggestions. When granted permission, the peripheral view generation module can use historical information as part of the contextual information for generating event-related information. In addition, standard web tracking methods and anonymity controls to preserve individual privacy can be utilized. For example, by assessing meeting information across a large number of anonymously collected calendars, it might be determined that “Harry's Restaurant” is a popular place to hold departmental business lunches where large numbers of employees are invited. “Harry's Restaurant” might then be presented in the peripheral view as an alternative venue to a user planning such a meeting with a large number of invitees.

In some cases, the historical information may be obtained from the user's own calendars. For example, the user's history indicating prior calendar entries social events at a particular restaurant or category of locations (e.g., type of restaurant, type of location such as store, restaurant, park) can be used to suggest events or locations for the user (e.g., a user having a history of Japanese restaurants may have a suggestion surface in a peripheral view of a new Japanese restaurant or an upcoming Japanese food festival occurring at the same time as the planned social outing).

In some cases, for example when given appropriate permissions, the historical information may be obtained from one or more invitees (as indicated on a calendar item of a meeting request). The historical information from the one or more invitees may be used to suggest an event or location, alone or in combination with user historical information. For example, reviewing both a user's and an invitee's historical information might reveal a common love of a particular restaurant that the parties had never specifically mentioned to one another.

Contextual information 160 may also include the geographical location of the user's or invitee(s)′ home or workplace (or other information that may be accessible as part of a user's contacts or a public directory). For example, if the user lives in Bellevue, Wash. and the invitee lives in the Issaquah, Wash., venues equidistant from both places might be shown in the peripheral view for a Saturday luncheon appointment.

Accordingly, in some cases, as events are created in a calendar 110, for example via a calendar item 111, the date and time 121 information can be used to scan available sources (e.g., associated calendars 140 and accessible information feeds 150) for events at or near that same date and time, and the location information can be used to scan the available sources for events that are in or near that same location. In some cases, additional information can be provided to supplement or affect the particular event-related information presented as part of the peripheral view. This additional information can be contextual information 160 as well as other inputs to the calendar item 111. Through the peripheral view 112, event-related information 115 (that relate to the date and time and/or location) can be provided within the context of event creation. In some cases, after events have been created, the peripheral view 112 can be used to facilitate the user's editing of the event item or to enable the user to double check that no new conflicts have arisen.

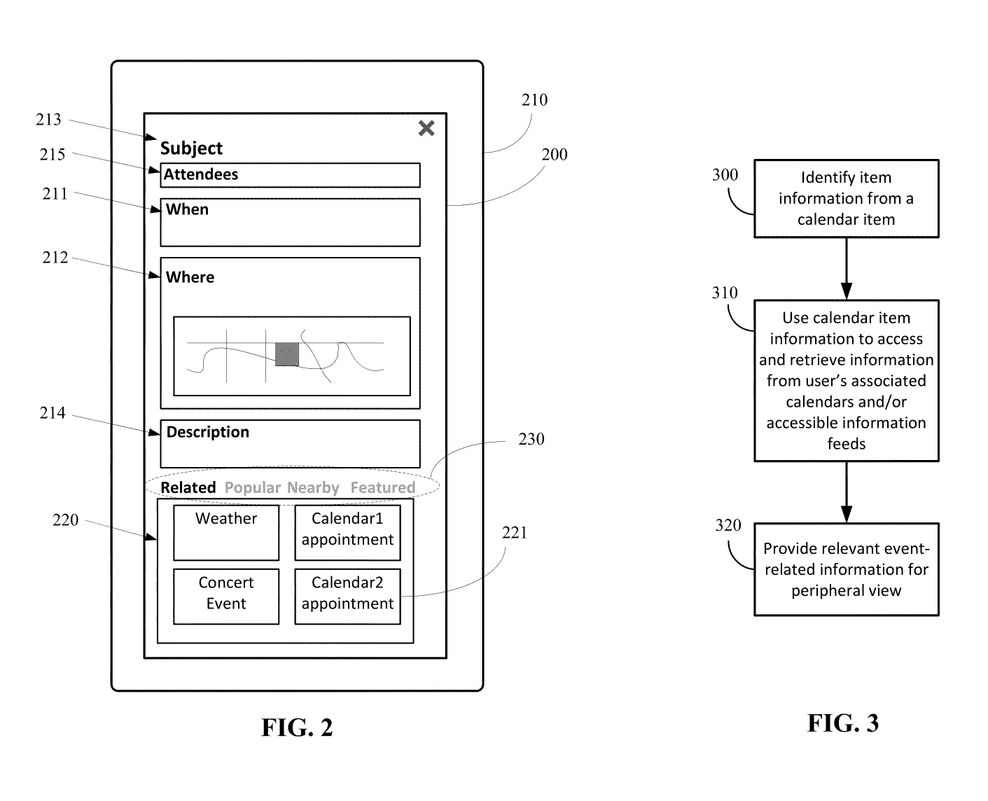

FIG. 2 illustrates an example detailed view of a calendar item with peripheral view. Referring to FIG. 2, a detailed view 200 of a calendar item is presented, for example on a mobile device 210 on which a calendar application is running. The detailed view 200 can provide an interface to view, edit, or draft details of an event. The detailed view 200 can include fields indicating item information such as date/time of an event 211, location of the event 212, subject of the event 213, a description of the event 214, attendees of the event 215, and the like. According to various implementations described herein, a calendar event peripheral view 220 is included as part of the detailed view 200 of the calendar item.

For example, in response to identifying the item information (e.g., at least one of date/time of an event 211, location of the event 212, subject of the event 213, a description of the event 214, attendees of the event 215) included in the detailed view 200 of the calendar item, relevant event-related information 221 can be surfaced as part of the detailed view 200 to provide the peripheral view 220. In some cases, the event-related information 221 can be dynamic in that each time the detailed view 200 of the calendar item is selected to view or edit (or the item information is modified), the item information is identified and used to retrieve at least one relevant event-related information from the available sources (such as those described with respect to FIGS. 1B and 1C). In some cases, the peripheral view 220 is available only in an editable detailed view the calendar item. In other cases, the peripheral view 220 is available in any detailed view.

In some cases, the peripheral view 220 may present a certain number of event-related information items 221. The number may be user-selected and/or programmatically determined as a fixed or client-dependent number. In some cases, the peripheral view may present the certain number of event-related information together. In some cases, the event-related information can be arranged or grouped by category. The categories 230 may be presented to the user in a single view (and either indicated as being associated with a particular category or provided without indication) or may provide filtering or sorting capabilities for the user while the user is in the calendar item so as to adjust the information presented within the peripheral view space. For example, categories 230 of event-related information may include related, popular, nearby, and featured (and the particular event-related information item 221 can be presented accordingly).

Each category may be populated with event-related information retrieved from appropriate sources with suitable queries. For example, related event-related information can be retrieved from the user's associated calendars and accessible information feeds. In the illustrated example, weather information, a concert event, and some appointments happening either near the same location as the event or around the same time as the event are surfaced. For the popular category, the event-related information may be retrieved, for example, from a ratings service queried using at least the date/time and location of the event. For the nearby category, the event-related information items can be based on the location of the event and/or location information related to the user or invitee. The featured category may be any event-related information item that the peripheral view generation module programmatically determines to be presented, for example, based on advertising or some other algorithm.

FIG. 3 illustrates an example process flow for enhancing a calendar item with a calendar event peripheral view. Referring to FIG. 3, item information from a calendar item can be identified (300). For example, user input to a draft calendar item via a calendar item entry form interface may be assigned or associated with identifiers for the calendar item information such as date/time and location. As described above, item information can include information such as the date and time of the proposed event, the location of the event, and the description of the event. In some cases, the description of the event may be interpreted using natural language processing functions to glean additional information for surfacing relevant event-related information.

In some implementations, user or invitee information may also be identified for use in retrieving supplemental information such as contextual information 160 described with respect to FIG. 1C.

The item information and optional supplemental information may then be used to generate relevant calendar-related information from one or more of an associated calendar of the user and an accessible information feed (310). For example, associated calendars and accessible information feeds may be accessed for information pertinent to the location, date/time, and description of the event (310).

Information retrieved from the user's associated calendars and/or accessible information feeds can be provided to surface as part of a peripheral view of a certain number of relevant event-related information items (320). The provided event-related information enhances the detailed view of the calendar item by the inclusion of a peripheral view of event-related information. This peripheral view can include one or more of relevant event-related information pertaining to calendar conflicts, potential inconveniences, alternate venue suggestions based on popularity and ratings, and alternate event suggestions based on identified common interests as just a few examples. The view of the calendar item may be a detailed view of a new or existing calendar item. For example, relevant event-related information may be surfaced in concert with the calendar item entry interface. The information retrieved from associated calendars and accessible information feeds can be sorted and/or filtered to select the certain number of and type of relevant event-information items that are surfaced in a view of the calendar item. The certain number may vary depending on implementation.

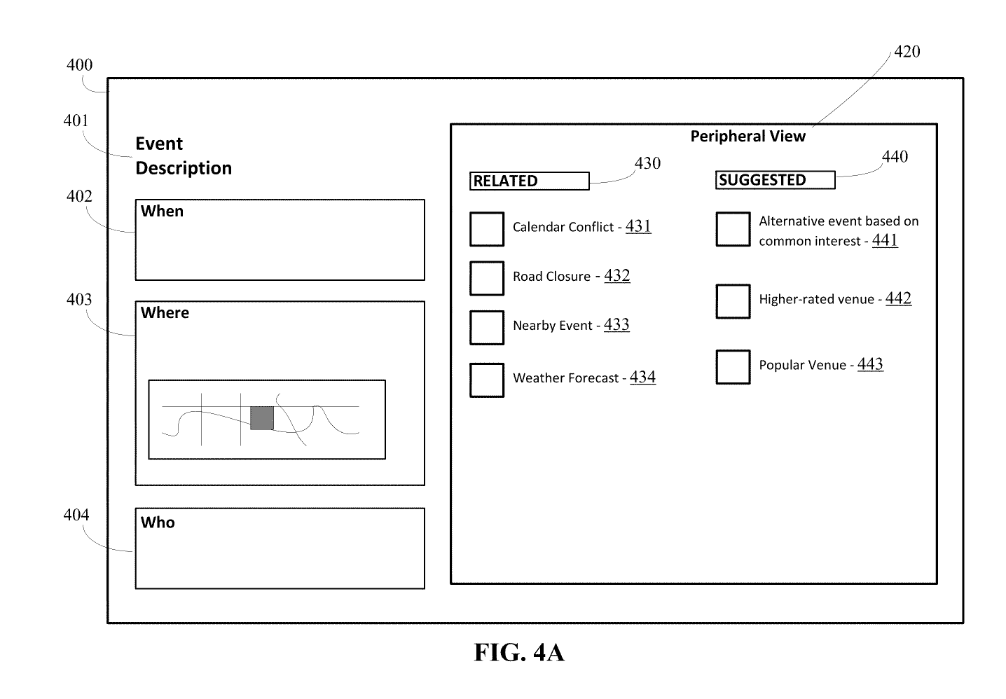

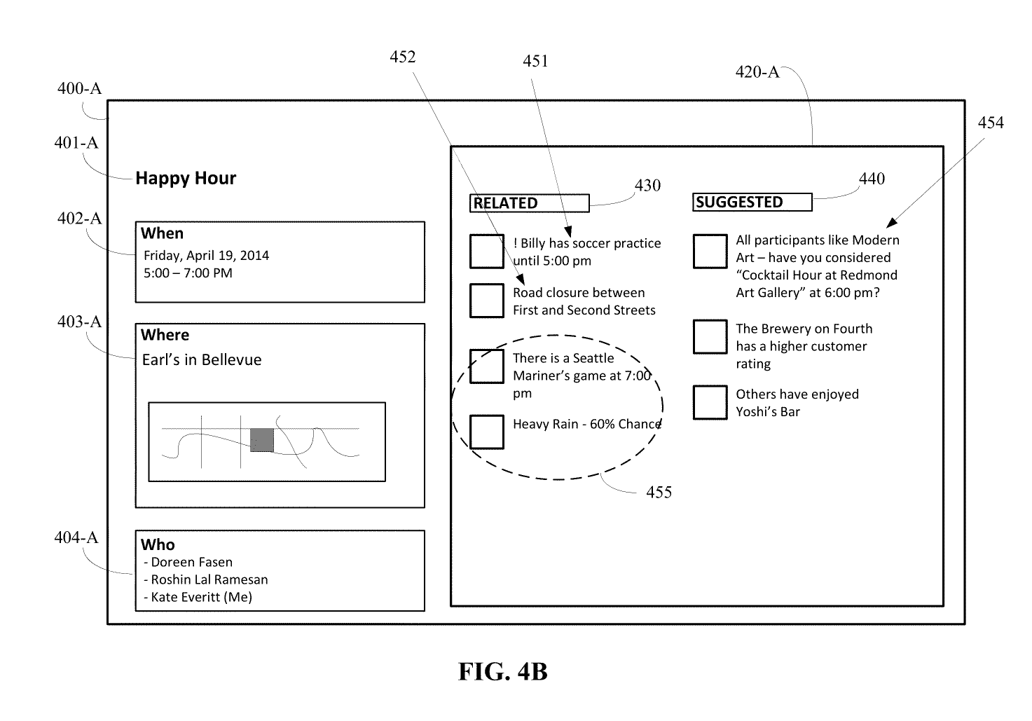

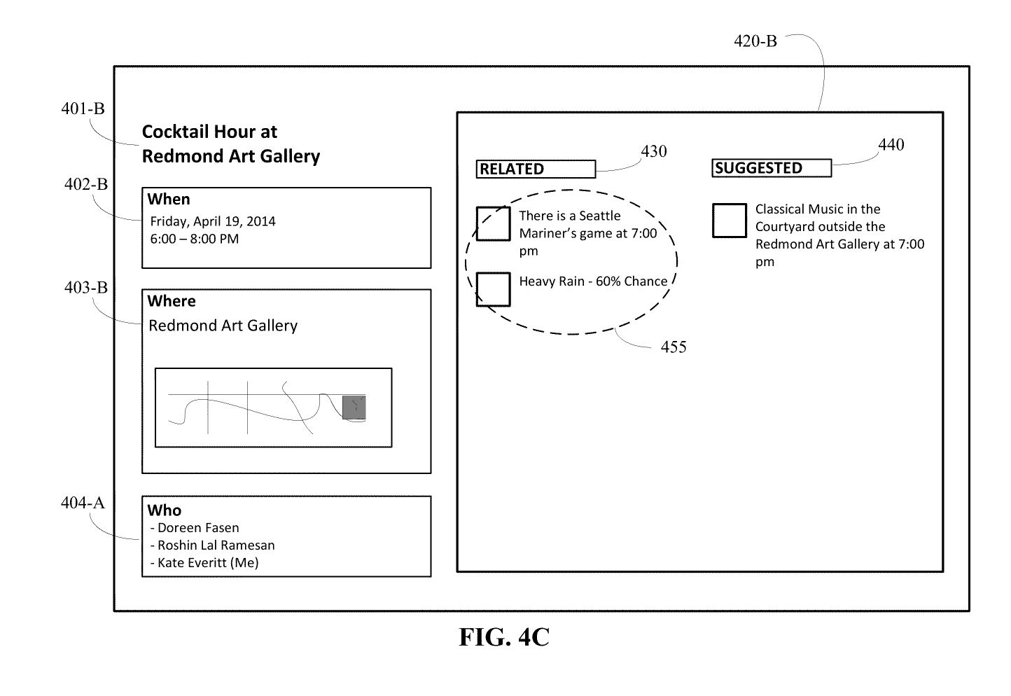

FIGS. 4A-4C illustrate an example scenario in which a calendar item may be enhanced with a calendar event peripheral view. It should be noted that this particular example of a peripheral view is for illustrative purposes only and is not intended to be limiting; many other configurations of a peripheral view are envisioned.

In the example in FIG. 4A, a user may open a “new appointment,” “new meeting request,” or an existing calendar item in a calendar application to launch a user interface window 400, providing creation, editing and/or viewing of details of a calendar item. Basic event information, such as an event description 401 (e.g., “subject”), time and date 402 (e.g., date and “all day” or start time and end time), location 403, and invitees 404 (if any), can be entered, modified, or viewed as is familiar to users of calendar applications. In some implementations, as information is populated in these areas, a peripheral view 420 of relevant event-related information can be dynamically surfaced. In some implementations, the relevant event-related information surfaces in response to a particular command.

In FIG. 4A, the peripheral view 420 is showing two types of event-related information, related information 430 and suggested information 440. The related information 430 may be information that can directly affect an event and is based on the date/time and location of the event. For example, calendar conflict(s) 431 with events scheduled in an associated calendar such as with the user's personal or a family member's calendar; road closure notification(s) 432; nearby event(s) 433; and a weather forecast 434 might be included as related information 430.

The suggested information 440 may be provided to indicate additional information about event and venue options that may pertain to the user's (or even invitee's) interests and/or an objective of the event. For example, an alternative event 441 (such as based on a common interest between the user and an invitee or just the user's interests); an alternative venue 442 (such as a different restaurant with a higher customer rating); a popular venue 443; and advertised venues (not shown) might be surfaced as suggested information 440.

The items listed in the “related” and “suggested” columns are merely example items that may be available based on the types of associated calendars, accessible information feeds, and interests discussed above with respect to FIG. 1C. The “related” and “suggested” information shown in any particular event's peripheral view can vary according to what was discovered by assessing the calendars, feeds, and interests from various available sources. Although a distinction between these two types of event-related information and their corresponding sets of information is made in this example, it should be understood that other types or groupings of event-related information are possible and the example is merely meant to be illustrative of one of many approaches that can be taken.

The peripheral view facilitates the user's ability to make informed decisions at the time of scheduling an event as well as make adjustment to their plans after an event has been saved. For example, a notification of a calendar conflict from a user's alternate calendar can help a user avoid scheduling a conflicting event. A road closure or major event conflict might lead the user to choose a different route or venue. A poor weather forecast might prompt the user to pick an indoor location or a forecast for sun might prompt the user to pick an outdoor location. Other suggestions might present opportunity moments to increase the value of a social occasion by identifying a common interest, or by finding a restaurant with better food than the “usual” place.

Thus, the techniques herein can help to avoid inefficient meeting rearrangements later in addition to presenting unforeseen opportunities for improved event experiences.

In FIG. 4B, after launching the user interface window 400, for example, for preparing a new calendar item for a “Happy Hour” event 400-A, the user may have entered a subject of “Happy Hour” (401-A), a date/time of Friday afternoon from 5:00 pm-7:00 pm (402-A) at Earl's in Bellevue (403-A), and invited co-workers (404-A) as the invitees.

Based on this calendar item information, a first peripheral view 420-A of event-related information can be surfaced. For example, based on the time and one of the user's associated calendars, event-related information relating to a calendar conflict 451 may surface. Based on the location of the happy hour event, information retrieved about the user's work address and/or home address (or location of an earlier meeting), and an information feed from a regional traffic and road closure information feed, event-related information relating to a travel issue 452 may be surfaced. Other event-related information such as the weather at the date/time (and location) identified from the calendar item and events from subscribed calendar information feeds or public event calendar that are happening around the same time can also be presented.

In addition, suggested events and venues 440 may be surfaced, providing additional or alternative ideas for the event. For example, when the user has integrated a social media account with their calendar application (or the calendar application accesses publically available information), locations that the user has “liked” may be presented. For example, each of the attendees of the event may have indicated that they “liked” the Redmond Art Gallery. This information combined with date and time information (e.g., Friday, Apr. 19, 2014 402-A) may be used to access the public event calendar of the Redmond Art Gallery for a suggested event 454.

In addition to suggested events, suggested venues may be presented. By accessing the customer ratings of Earl's and several other nearby establishments (e.g., on a service such as Yelp®), a high rated location may be presented. Another suggested venue may be determined using historical information of the user (or aggregated information from across many users).

In some implementations, a user may select one of the event-related information item to change the calendar item information. For example, the user may like the idea of attending the Redmond Art Gallery event 454 and can select that event to update the event information, as illustrated in FIG. 4C.

In FIG. 4C the selection of the event 454 has updated the calendar item details. In the figure, the event description has been modified to “Cocktail Hour at Redmond Art Gallery” (401-B); the time of the event has been altered to indicate a time of 6:00 pm-8:00 pm (402-B); and the location of the event has been updated to the Redmond Art Gallery (403-B).

As the calendar item information is modified, so too may the items in the peripheral view be updated. For example, an updated peripheral view 420-B can surface based on current item information. Here, the conflict with Billy's soccer practice (451) has been removed, since the event time was moved to a time when that event is no longer a conflict. Also, item 452, the road closure notice, may be removed, since the new venue location may no longer involve the blocked streets as a possible travel route. Remaining in the peripheral view 420-B, however, are the items 455, which continued to be relevant for the new time and location. The recommendations in the “suggested” category have also modified to reflect the new event selection. The dynamic aspect of the peripheral view shows how the techniques herein may enable more rewarding, spontaneous, and relevant calendar events and plans.

Certain aspects of the invention provide the following non-limiting embodiments:

### Example 1

A method for enhancing the presentation of calendar items, comprising: presenting a detailed view of a calendar item; identifying item information included in the detailed view of the calendar item; using the item information to retrieve at least one relevant event-related information from one or more of an associated calendar of the user and an accessible information feed; and enhancing the detailed view of the calendar item with the relevant event-related information.

### Example 2

The method according to example 1, wherein the item information comprises a date and time information and a location information of the calendar item.

### Example 3

The method according to examples 1 or 2, wherein the item information comprises a future date and time.

### Example 4

The method according to any of examples 1-3, wherein identifying the item information comprises: receiving content via input fields for the detailed view of the calendar item.

### Example 5

The method according to any of examples 1-4, wherein the accessible information feed comprises a public calendar subscribed to by at least one of a user and an invitee.

### Example 6

The method according to any of examples 1-5, further comprising using one or more of an interest of the user, a history of prior events of the user, a history of prior venues of the user, and a location of the user to determine one or more of the at least one relevant event-related information.

### Example 7

The method according to any of examples 1-6, wherein using the item information to retrieve the at least one relevant event-related information from the one or more of the associated calendar of the user and the accessible information feed comprises: searching the associated calendar for events occurring at a same date as a date of the item information identified from the detailed view of the calendar item.

### Example 8

The method according to any of examples 1-7, wherein using the item information to retrieve the at least one relevant event-related information from the one or more of the associated calendar of the user and the accessible information feed comprises: searching a public calendar source for events occurring at a same date as a date of the item information identified from the detailed view of the calendar item and within a determined distance from a location of the item information identified from the detailed view of the calendar item.

### Example 9

The method according to any of examples 1-8, further comprising using one or more of an interest of the user, a history of prior events of the user, a history of prior venues of the user, and a location of the user to retrieve the relevant event-related information.

### Example 10

The method according to any of examples 1-9, further comprising using one or more of an interest of an invitee, a history of prior events of an invitee, a history of prior venues of an invitee, and a location of an invitee to retrieve the relevant event-related information.

### Example 11

A method for enhancing the presentation of calendar items, comprising: receiving at least a first date/time information and a first location information from a detailed view of a calendar item; requesting event-related information from one or more of an associated calendar of the user and an accessible information feed using at least one of the first date/time information and the first location information; and providing at least one of the event-related information from the one or more of the associated calendar and the accessible information feed with the detailed view of the calendar item.

### Example 12

The method according to example 11, further comprising: in response to receiving a second date/time information or a second location information from the detailed view of the calendar item, requesting updated event-related information from the one or more of the associated calendar and the accessible information feed and providing at least one of the updated event-related information with the detailed view of the calendar item.

### Example 13

The method according to examples 11 or 12, wherein the accessible information feed comprises at least one of a public event calendar, a user's subscribed calendar, a traffic information feed, a weather information feed, a ratings service, an advertising feed, and social media.

### Example 14

The method according to any of examples 11-13, wherein the at least one relevant event-related information comprises a suggestion for one or more public events.

### Example 15

The method according to any of examples 11-14, wherein the relevant event-related information comprises one or more events within a particular distance of the first location.

### Example 16

The method according to any of examples 11-15, wherein the relevant event-related information comprises one or more locations within a particular distance of the first location.

### Example 17

The method according to any of examples 11-16, wherein the relevant event-related information comprises one or more locations indicated as having a higher review rating than the first location.

### Example 18

An apparatus comprising: one or more computer readable storage media; and a calendar application including a peripheral view generation module, the application embodied in program instructions stored on the one or more computer readable media that, when executed by a processing system, direct the processing system to: identify item information of a calendar item; generate relevant event-related information from one or more of an associated calendar of a user and an accessible information feed; and surface a peripheral view of the relevant event-related information when providing a detailed view of the calendar item.

### Example 19

The apparatus according to example 18, wherein at least one of the relevant event-related information comprises a conflicting event retrieved from an associated calendar item of the associated calendar.

### Example 20

The apparatus according to examples 18 or 19, wherein at least one of the relevant event-related information comprises a suggested event retrieved from the accessible information feed.

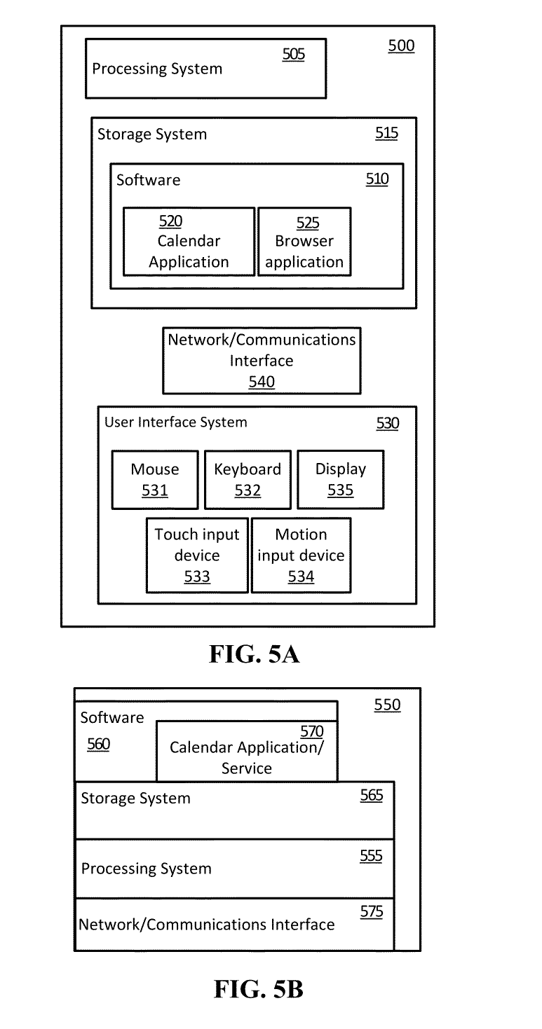

FIGS. 5A and 5B present block diagrams illustrating components of systems that may be used to implement the techniques described herein.

Referring to FIG. 5A, system 500 may represent a computing device such as, but not limited to, a personal computer, a tablet computer, a reader, a mobile device, a personal digital assistant, a wearable computer, a smartphone, a laptop computer (notebook or netbook), a gaming device or console, a desktop computer, or a smart television. Accordingly, more or fewer elements described with respect to system 500 may be incorporated to implement a particular computing device.

System 500, for example, includes a processing system 505 of one or more processors to transform or manipulate data according to the instructions of software 510 stored on a storage system 515. Examples of processors of the processing system 505 include general purpose central processing units, application specific processors, and logic devices, as well as any other type of processing device, combinations, or variations thereof.

The software 510 can include an operating system and application programs such as a calendar application 520 and/or web browsing application 525. In some cases, the software 510 can include a peripheral view generation module or service (e.g., 120 of FIGS. 1A-1C). Device operating systems generally control and coordinate the functions of the various components in the computing device, providing an easier way for applications to connect with lower level interfaces like the networking interface. Non-limiting examples of operating systems include Windows® from Microsoft Corp., Apple® iOS™ from Apple, Inc., Android® OS from Google, Inc., and the Ubuntu variety of the Linux OS from Canonical.

It should be noted that the operating system may be implemented both natively on the computing device and on software virtualization layers running atop the native device operating system (OS). Virtualized OS layers, while not depicted in FIG. 5A, can be thought of as additional, nested groupings within the operating system space, each containing an OS, application programs, and APIs.

Storage system 515 may comprise any computer readable storage media readable by the processing system 505 and capable of storing software 510 including the calendar application 520 and/or browsing application 525.

Storage system 515 may include volatile and nonvolatile, removable and non-removable media implemented in any method or technology for storage of information, such as computer readable instructions, data structures, program modules, or other data. Examples of storage media include random access memory, read only memory, magnetic disks, optical disks, CDs, DVDs, flash memory, virtual memory and non-virtual memory, magnetic cassettes, magnetic tape, magnetic disk storage or other magnetic storage devices, or any other suitable storage media. In no case is the storage medium a propagated signal or carrier wave.

In addition to storage media, in some implementations, storage system 515 may also include communication media over which software may be communicated internally or externally. Storage system 515 may be implemented as a single storage device but may also be implemented across multiple storage devices or sub-systems co-located or distributed relative to each other. Storage system 520 may include additional elements, such as a controller, capable of communicating with processor 505.

Software 510 may be implemented in program instructions and among other functions may, when executed by system 500 in general or processing system 505 in particular, direct system 500 or the one or more processors of processing system 505 to operate as described herein.

In general, software may, when loaded into processing system 505 and executed, transform computing system 500 overall from a general-purpose computing system into a special-purpose computing system customized to retrieve and process the information for a calendar event peripheral view as described herein for each implementation. Indeed, encoding software on storage system 515 may transform the physical structure of storage system 515. The specific transformation of the physical structure may depend on various factors in different implementations of this description. Examples of such factors may include, but are not limited to the technology used to implement the storage media of storage system 515 and whether the computer-storage media are characterized as primary or secondary storage.

The system can further include user interface system 530, which may include input/output (I/O) devices and components that enable communication between a user and the system 500. User interface system 530 can include input devices such as a mouse 531, track pad (not shown), keyboard 532, a touch device 533 for receiving a touch gesture from a user, a motion input device 534 for detecting non-touch gestures and other motions by a user, a microphone for detecting speech (not shown), and other types of input devices and their associated processing elements capable of receiving user input.

The user interface system 530 may also include output devices such as display screens 535, speakers (not shown), haptic devices for tactile feedback (not shown), and other types of output devices. In certain cases, the input and output devices may be combined in a single device, such as a touchscreen display which both depicts images and receives touch gesture input from the user. Visual output may be depicted on the display 535 in myriad ways, presenting graphical user interface elements, text, images, video, notifications, virtual buttons, virtual keyboards, or any other type of information capable of being depicted in visual form.

The user interface system 530 may also include user interface software and associated software (e.g., for graphics chips and input devices) executed by the OS in support of the various user input and output devices. The associated software assists the OS in communicating user interface hardware events to application programs using defined mechanisms. The user interface system 530 including user interface software may support a graphical user interface, a natural user interface, or any other type of user interface. For example, the detailed view of the calendar item containing peripheral view functionality described herein may be presented through user interface system 530.

Communications interface 540 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS, which informs applications of communications events when necessary.

It should be noted that many elements of system 500 may be included in a system-on-a-chip (SoC) device. These elements may include, but are not limited to, the processing system 505, a communications interface 540, and even elements of the storage system 515.

Computing system 500 is generally intended to represent a computing system with which software is deployed and executed in order to implement an application, component, or service for a calendar application with a calendar event peripheral view, as described herein. In some cases, aspects of computing system 500 may also represent a computing system on which software may be staged and from where software may be distributed, transported, downloaded, or otherwise provided to yet another computing system for deployment and execution, or yet additional distribution.

Certain aspects described herein may be carried out on a system such as shown in FIG. 5B. Referring to FIG. 5B, system 550 may be implemented within a single computing device or distributed across multiple computing devices or sub-systems that cooperate in executing program instructions. The system 550 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 550 can include a processing system 555, which may include one or more processors and/or other circuitry that retrieves and executes software 560 from storage system 565. Processing system 555 may be implemented within a single processing device but may also be distributed across multiple processing devices or sub-systems that cooperate in executing program instructions.

Examples of processing system 555 include general purpose central processing units, application specific processors, and logic devices, as well as any other type of processing device, combinations, or variations thereof. The one or more processing devices may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain embodiments, one or more digital signal processors (DSPs) may be included as part of the computer hardware of the system in place of or in addition to a general purpose CPU.

As with storage system 515, storage system 565 can include any computer readable storage media readable by processing system 555 and capable of storing software 560. Storage system 565 may be implemented as a single storage device but may also be implemented across multiple storage devices or sub-systems co-located or distributed relative to each other. Storage system 565 may include additional elements, such as a controller, capable of communicating with processing system 555.

Software 560 may be implemented in program instructions and among other functions may, when executed by system 550 in general or processing system 555 in particular, direct the system 550 or processing system 555 to operate as described herein for enabling a calendar event peripheral view. Software 560 may provide program instructions that implement a calendar application 570 as well as (or alternatively) provide program instructions for enabling a calendar event peripheral view.

Software 560 may also include additional processes, programs, or components, such as operating system software or other application software. Software 560 may also include firmware or some other form of machine-readable processing instructions executable by processing system 555.

System 550 may represent any computing system on which software 560 may be staged and from where software 560 may be distributed, transported, downloaded, or otherwise provided to yet another computing system for deployment and execution, or yet additional distribution.

In embodiments where the system 550 includes multiple computing devices, the server can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 575 may be included, providing communication connections and devices that allow for communication between system 550 and other computing systems (not shown) over a communication network or collection of networks (not shown) or the air.

It should be noted that many elements of system 550 may be included in a system-on-a-chip (SoC) device. These elements may include, but are not limited to, the processing system 555, the communications interface 575, and even elements of the storage system 565.

FIG. 6 illustrates an example system architecture in which the described systems and techniques may be carried out. Referring to FIG. 6, a calendar application 601 may be implemented on a computing system 600-A such as described with respect to system 500 of FIG. 5A. The user of the calendar application 601 may utilize the application to create, edit, or view a calendar item. System 600-A may make available to calendar application 601, either as integral to it or as available functionality, an implementation of a peripheral view generation module 610 as described above with respect to peripheral view generation module 120 of FIGS. 1A-1C.

Calendar application 601 may communicate over network 620 with associated calendar service(s) 625 contained on system 600-B, which is a particular instance of system 550 described in FIG. 5B. Calendar service(s), of which there may be several types, vendors or providers, and access methods, may be embodied in data structures and processing functions allowing accessibility and interchange with calendar applications 601. Associated calendars, such as described with respect to associated calendars 140 of FIG. 1C, may be accessed via the associated calendar service(s) 625.

Calendar application 601 may also communicate over network 620 with accessible information feed service(s) 626 embodied as system 600-C, which is a particular instance of system 550 described in FIG. 5B. Accessible information feed service(s), of which there may be several types, vendors or providers, and access methods, may be embodied in data structures and processing functions allowing accessibility and interchange with calendar application 601. Examples of accessible information feed services were described above with reference to information feed services 150 of FIG. 1C.

Calendar application 601 and/or peripheral view generation module 610 may in some instances communicate with services 625 and 626 using application programming interfaces (APIs) to send requests and receive information.

An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. An API can be used to access a service or data provided by the API-implementing component or to initiate performance of an operation or computation provided by the API-implementing component. By way of example, the API-implementing component and the API-calling component may each be any one of an operating system, a library, a device driver, an API, an application program, or other module (it should be understood that the API-implementing component and the API-calling component may be the same or different type of module from each other). API-implementing components may in some cases be embodied at least in part in firmware, microcode, or other hardware logic.

The API-calling component may be a local component (i.e., on the same data processing system as the API-implementing component) or a remote component (i.e., on a different data processing system from the API-implementing component) that communicates with the API-implementing component through the API over a network. An API is commonly implemented over the Internet such that it consists of a set of Hypertext Transfer Protocol (HTTP) request messages and a specified format or structure for response messages according to a REST (Representational state transfer) or SOAP (Simple Object Access Protocol) architecture. Here, calendar application 601 and peripheral view generation module 610 may connect to remote services 625 and 626 over the Internet using APIs structured using the REST or SOAP protocols.

The network 620 can include, but is not limited to, a cellular network (e.g., wireless phone), a point-to-point dial up connection, a satellite network, the Internet, a local area network (LAN), a wide area network (WAN), a WiFi network, an ad hoc network, an intranet, an extranet, or a combination thereof. The network may include one or more connected networks (e.g., a multi-network environment) including public networks, such as the Internet, and/or private networks such as a secure enterprise private network.

In another example implementation scenario, calendar application 601 running on a computing device 600-E, such as described with respect to system 500 of FIG. 5A, may communicate with a peripheral view generation service 630 hosted on separate physical or virtual system 600-F, which may be embodied on a system such as described with respect to system 550 of FIG. 5B. Peripheral view service 630 may perform techniques for identifying information item information from a calendar item, accessing associated calendar(s) and accessible information feed(s), and retrieving relevant event-related information. This information may then be communicated to calendar application 601 (and a local component for peripheral view) for further interpretation or rendering. Systems containing calendar application 601 and peripheral view service 630 may communicate with one another via API or other communication standard over network 620 as described above.

It should be understood that the examples and embodiments described herein are for illustrative purposes only and that various modifications or changes in light thereof will be suggested to persons skilled in the art and are to be included within the spirit and purview of this application.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts that would be recognized by one skilled in the art are intended to be within the scope of the claims.

What is claimed is:

1. A method for enhancing the presentation of calendar items, comprising:
presenting a detailed view of a calendar item;
identifying item information included in the detailed view of the calendar item;
using the item information to retrieve at least one relevant event-related information from one or more of an associated calendar of the user and an accessible information feed; and
enhancing the detailed view of the calendar item with the relevant event-related information.

2. The method of claim 1, wherein the item information comprises a date and time information and a location information of the calendar item.

3. The method of claim 1, wherein the item information comprises a future date and time.

4. The method of claim 1, wherein identifying the item information comprises: receiving content via input fields for the detailed view of the calendar item.

5. The method of claim 1, wherein the accessible information feed comprises a public calendar subscribed to by at least one of a user and an invitee.

6. The method of claim 1, further comprising using one or more of an interest of the user, a history of prior events of the user, a history of prior venues of the user, and a location of the user to determine one or more of the at least one relevant event-related information.

7. The method of claim 1, wherein using the item information to retrieve the at least one relevant event-related information from the one or more of the associated calendar of the user and the accessible information feed comprises:
searching the associated calendar for events occurring at a same date as a date of the item information identified from the detailed view of the calendar item.

8. The method of claim 1, wherein using the item information to retrieve the at least one relevant event-related information from the one or more of the associated calendar of the user and the accessible information feed comprises:
searching a public calendar source for events occurring at a same date as a date of the item information identified from the detailed view of the calendar item and within a determined distance from a location of the item information identified from the detailed view of the calendar item.

9. The method of claim 1, further comprising using one or more of an interest of the user, a history of prior events of the user, a history of prior venues of the user, and a location of the user to retrieve the relevant event-related information.

10. The method of claim 1, further comprising using one or more of an interest of an invitee, a history of prior events of an invitee, a history of prior venues of an invitee, and a location of an invitee to retrieve the relevant event-related information.

11. A method for enhancing the presentation of calendar items, comprising:
receiving at least a first date/time information and a first location information from a detailed view of a calendar item;
requesting event-related information from one or more of an associated calendar of the user and an accessible information feed using at least one of the first date/time information and the first location information; and
providing at least one of the event-related information from the one or more of the associated calendar and the accessible information feed with the detailed view of the calendar item.

12. The method of claim 11, further comprising:
in response to receiving a second date/time information or a second location information from the detailed view of the calendar item, requesting updated event-related information from the one or more of the associated calendar and the accessible information feed and providing at least one of the updated event-related information with the detailed view of the calendar item.

13. The method of claim 11, wherein the accessible information feed comprises at least one of a public event calendar, a user's subscribed calendar, a traffic information feed, a weather information feed, a ratings service, an advertising feed, and social media.

14. The method of claim 11, wherein the at least one relevant event-related information comprises a suggestion for one or more public events.

15. The method of claim 11, wherein the relevant event-related information comprises one or more events within a particular distance of the first location.

16. The method of claim 11, wherein the relevant event-related information comprises one or more locations within a particular distance of the first location.

17. The method of claim 11, wherein the relevant event-related information comprises one or more locations indicated as having a higher review rating than the first location.

18. An apparatus comprising:
one or more computer readable storage media; and
a calendar application including a peripheral view generation module, the application embodied in program instructions stored on the one or more computer readable media that, when executed by a processing system, direct the processing system to:
identify item information of a calendar item;
generate relevant event-related information from one or more of an associated calendar of a user and an accessible information feed; and
surface a peripheral view of the relevant event-related information when providing a detailed view of the calendar item.

19. The apparatus of claim 18, wherein at least one of the relevant event-related information comprises a conflicting event retrieved from an associated calendar item of the associated calendar.

20. The apparatus of claim 18, wherein at least one of the relevant event-related information comprises a suggested event retrieved from the accessible information feed.
